(19) United States
(12) Patent Application Publication
(10) Pub. No.: US 2017/0108131 A1
(43) Pub. Date: Apr. 20, 2017

(54) CHECK VALVE

(71) Applicant: Flomatic Corporation, Glens Falls, NY (US)

(72) Inventor: Allan Bo Andersson, Cambridge, NY (US)

(73) Assignee: Flomatic Corporation, Glens Falls, NY (US)

(21) Appl. No.: 14/887,826

(22) Filed: Oct. 20, 2015

(51) Int. Cl. F16K 15/02; F16K 27/02

(52) U.S. Cl. CPC F16K 15/025; F16K 27/0209

(57) ABSTRACT

A check valve is provided which may be installed horizontally or in other non-vertical orientations, and used with variable frequency drives and other applications without the valve becoming misaligned. In one aspect, the valve includes a housing with an inner surface and a passage. A flange within the housing divides the housing into upstream and downstream portions, and extends around the inner surface, defining a valve seat and a valve aperture. A poppet is positioned in the downstream portion. The poppet includes a valve head and a plurality of guide legs extending from the valve head and into the downstream portion, and not through the valve aperture. The valve head is resiliently biased in the closed position against the valve seat to inhibit fluid flow in a first direction. A guide disposed within the housing receives the plurality of guide legs of the poppet valve as the poppet valve moves between an open position and a closed position.

### TECHNICAL FIELD

This invention relates generally to the field of valves, and more specifically, to valves capable of tolerating a variable flow of fluid.

### BACKGROUND OF THE INVENTION

Check valves are designed to permit the flow of fluid in one direction while preventing the fluid from flowing in the reverse direction. Conventional check valves utilize a single poppet valve within a body which controls the flow of fluid therethrough. However, conventional poppet valves are likely to become lodged in the interior seat provided by an annular flange within the valve body. When this happens, it is almost impossible to dislodge the poppet valve without dismantling the check valve or utilizing a new fitting. Moreover, conventional valves are difficult to assemble and may include many parts and fasteners. It may also be awkward to assemble and/or repair valves, as different parts can be located on opposite sides of a valve seat or flange formed within the valves.

### SUMMARY OF THE INVENTION

The shortcomings of the prior art may be alleviated by using a valve in accordance with one or more principles of the present invention. The valve of the present invention may be used in any type of hydraulic or other fluid flow lines such as, for example, water, fuel, or gas lines, wells, cisterns, submersible pump applications, pumping outfits or the like. Additionally, other uses may be made of the invention that fall within the scope of the claimed invention but which are not specifically described below.

In one aspect of the invention, there is provided a check valve including a housing that includes an inner periphery surface defining a passage therethrough between an inlet port and an outlet port. The check valve also includes a flange within the housing that divides the passage between the inlet and outlet ports into an upstream portion and a downstream portion. The flange extends circumferentially around the inner periphery surface of the housing. The flange also defines a valve seat and has an inner surface that defines a valve aperture. A poppet valve is positioned in the downstream portion of the passage of the housing. The poppet valve includes a valve disk and a plurality of guide legs extending from the valve disk towards the outlet port of the housing. The valve disk engages the valve seat of the flange and is moveable between a closed position to a fully open position. The valve disk is resiliently biased in the closed position against the valve seat to inhibit fluid flow in a first direction and allow fluid flow in an opposite direction to the first direction. A guide is mounted on the inner periphery surface of the housing. The guide guides the plurality of guide legs of the poppet valve as the poppet valve moves between the closed position and the fully open position.

In another aspect, an outer diameter formed by the outer surfaces of the plurality of guide legs is approximately forty percent of the outer diameter formed by the outer peripheral of the valve head.

Additional features and benefits will become apparent from the following drawings and descriptions of the invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the end of the specification. The foregoing and other objects, features, and advantages of the invention are apparent from the following detailed description taken in conjunction with the accompanying drawings in which:

FIG. 1 depicts a longitudinal cross-sectional view through a check valve constructed in accordance with one or more principles of the present invention, and illustrating the valve in an open position;

FIG. 2 depicts a longitudinal cross-sectional view through a check valve constructed in accordance with one or more principles of the present invention, and illustrating the valve in an closed position; and

FIG. 3 depicts a perspective view of one embodiment of a poppet valve constructed in accordance with one or more principles of the present invention.

### DETAILED DESCRIPTION OF EMBODIMENTS OF THE INVENTION

For the purposes of promoting an understanding of the principles of a valve designed and constructed in accordance with one or more aspects of the present invention, reference will now be made to the embodiments, or examples, illustrated in the drawings and specific language will be used to describe these. It will nevertheless be understood that no limitation of the scope of the invention is thereby intended. Any alterations and further modifications in the described embodiments, and any further applications of the principles of the invention as described herein are contemplated as would normally occur to one skilled in the art to which the check valve invention relates.

Presented herein is an improved valve capable of handling variable fluid flow in either a vertical or horizontal direction. In traditional applications of fluid control valves, the rate of fluid flow was either very high or very low. Thus, a valve disk would always need to be positioned either in the maximum open position or the maximum closed position to operate properly. However, more recently, variable frequency drives have been used to power pumps, resulting in a variable rate of fluid flow. The variable rate of fluid flow may cause a valve to be disposed at a distance between the maximum open position and the closed position. However, traditional valves do not function properly when used in connection with these variable frequency drive pumps because the pressure exerted against the valve disk is insufficient to displace it to the maximum open position.

Conventional check valves include a valve disk in a downstream portion of a valve connected to a stem extending through a valve aperture and into an upstream portion of the valve. These check valves also include a rubber disk that cooperates with a valve seat forming the valve aperture. The rubber disk seals with the valve seat to prevent leakage of fluid when the valve is in the closed position. This rubber seal is positioned between a valve disk and a valve stem and held tightly by a fastener connecting the valve disk to the valve stem. An example of a valve having this configuration is described in more detail in U.S. Pat. No. 6,581,633 to Andersson, which is hereby incorporated herein by reference. However, assembly and/or repair of these valves are difficult because the valve disk and the valve stem are located on opposite sides of the valve seat or flange formed within the valves.

Alternative check valve designs include a valve disk in a downstream portion of a valve connected to a stem or shaft extending away from, and not through, a valve aperture and into a downstream portion of the valve. The valve head or disk is biased, by a spring, against a valve seat forming the valve aperture. The valve disk seals with the valve seat to prevent leakage of fluid when the valve is in the closed position. The stem or shaft is telescopically received by a guide mounted on the inner surface of the valve housing in the downstream portion. The guide telescopically receives the stem or shaft as the poppet valve moves between an open and closed position relative to the valve seat. The guide includes a bushing in contact with the stem. A bushing is used to reduce wear on the guide and stem. An example of a valve having this configuration is described in more detail in U.S. Pat. No. 9,032,992 to Andersson, which is hereby incorporated herein by reference. However, the guide bushing used in these designs causes friction loss and results in reduced flow areas. Also, assembly of these valves requires more parts and time. The use of a valve stem in conventional check valves also includes smaller diameter shafts that fail to provide the necessary support or guiding surface to react to the changes in hydraulic pressure incurred during abrupt changes in frequency and changes in rpms of pumps used in a hydraulic system. Since the guiding surface of conventional valve stems experience significant action when used in frequency drives, the valve tends to wear out and become unstable during operation.

Current check valve designs are compromised due to a lack of stability when they are not in a fully open or fully closed position. This lack of stability in partially open positions compromises the utility of these valves in connection with pumps that employ variable frequency drives. Pumps with variable frequency drives are capable of generating varying rates of fluid flow. At times, the variable fluid flow may be capable of overcoming the force of spring required to keep the valve disk in contact with flange, but insufficient to displace valve disk to a fully open position. In traditional check valves, when a valve disk is displaced from a flange but not in a fully open position, the flow of fluid may cause the valve disk to become misaligned.

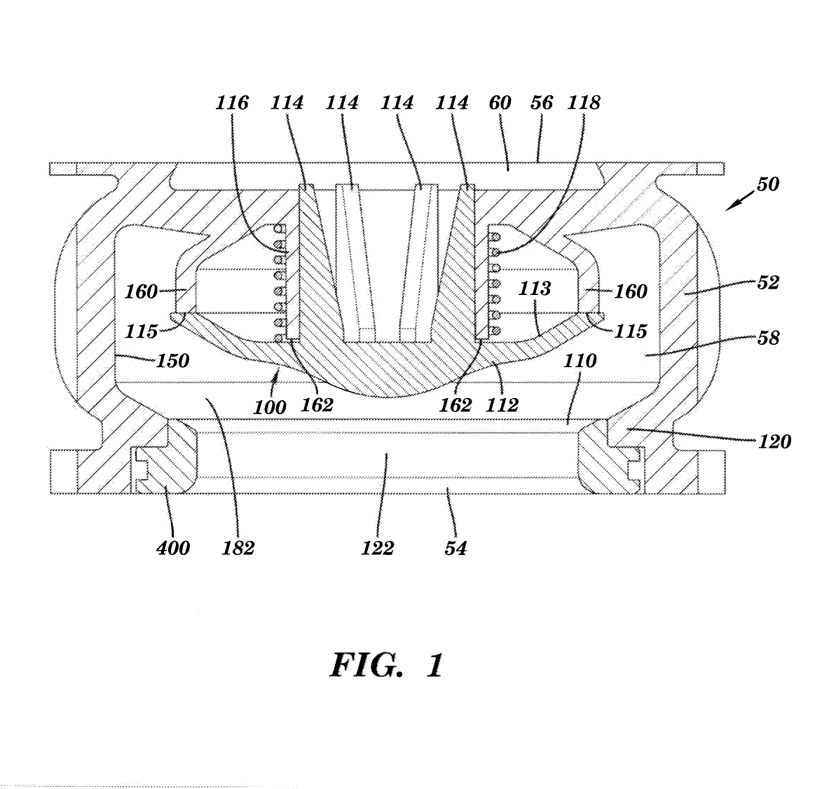

In the illustrative embodiment shown in FIG. 1, a valve 50 includes a tubular casing or housing 52 containing a poppet valve 100 designed and constructed in accordance with one or more aspects of the present invention. Housing 52 defines a passage 58 having an inlet port 54 and an outlet port 56. Valve 50 includes an upstream portion 182, generally between inlet port 54 and poppet valve 100, and a downstream portion 60, generally between outlet port 56 and poppet valve 100. Fluid enters inlet port 54, which is upstream from poppet valve 100 and flows towards outlet port 56, which is downstream from poppet valve 100. Within tubular housing 52, an inwardly extending circumferential flange 120 protruding from an inner surface 150 of the housing forms a valve aperture 122. Typically, flange 120 is circular in shape as defined by its inner surface forming valve aperture 122. However, valve aperture 122 is not limited to any particular geometrical shape. A valve seat 110 may be generally circular in shape and is formed by, for example, flange 120. In one example, valve seat 110 is angled in forty-five degrees to provide a larger seating surface and allow more seating area of valve disk or head 112.

In an alternative embodiments, valve 50 may include a replaceable seat 400 disposed on flange 120. Seat 400 may be permanently or removably affixed to flange 120. In one embodiment, seat 400 may be disposed within housing 52 and adjacent flange 120 before poppet valve 100 is disposed within housing 52. Replaceable seat 400 may be removed and alternative seat 400 may be placed within housing 52. Seat 400 may be made, for example, of a material different than material of housing 52 or flange 120. For example, in one embodiment, seat 400 can be made of rubber.

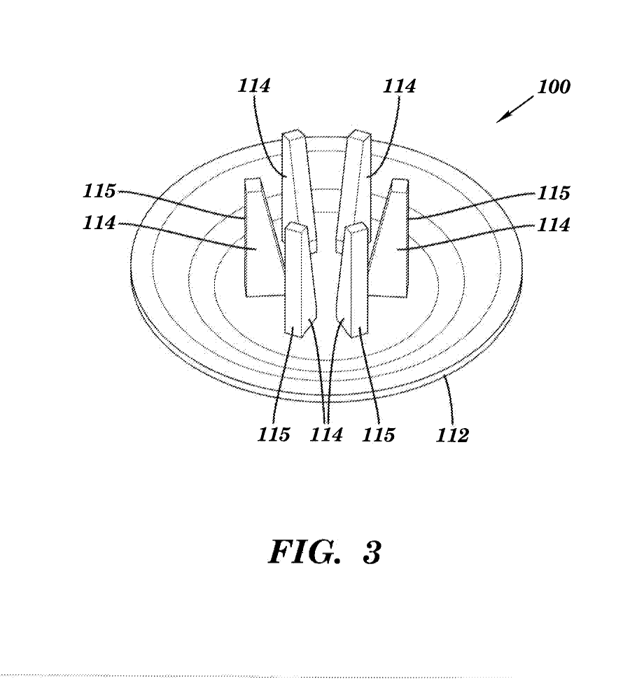

Poppet valve 100 is moveably mounted within housing 52 in passage 58 between flange 120 and outlet port 56. One example of a poppet valve 100 constructed in accordance with one or more aspects of the invention is depicted in FIG. 3. Poppet valve 100 includes a valve head or disk 112 and a plurality of guide legs 114 extending from valve head or disk 112 and into downstream portion 60 of tubular housing 52. In one example, the edge of the base of valve disk 112 is annular, having a diameter greater than the diameter of valve seat 110. In another example, the outer surface of valve disk or head 112 facing valve aperture 122 is cone-shaped to provide more laminar flow.

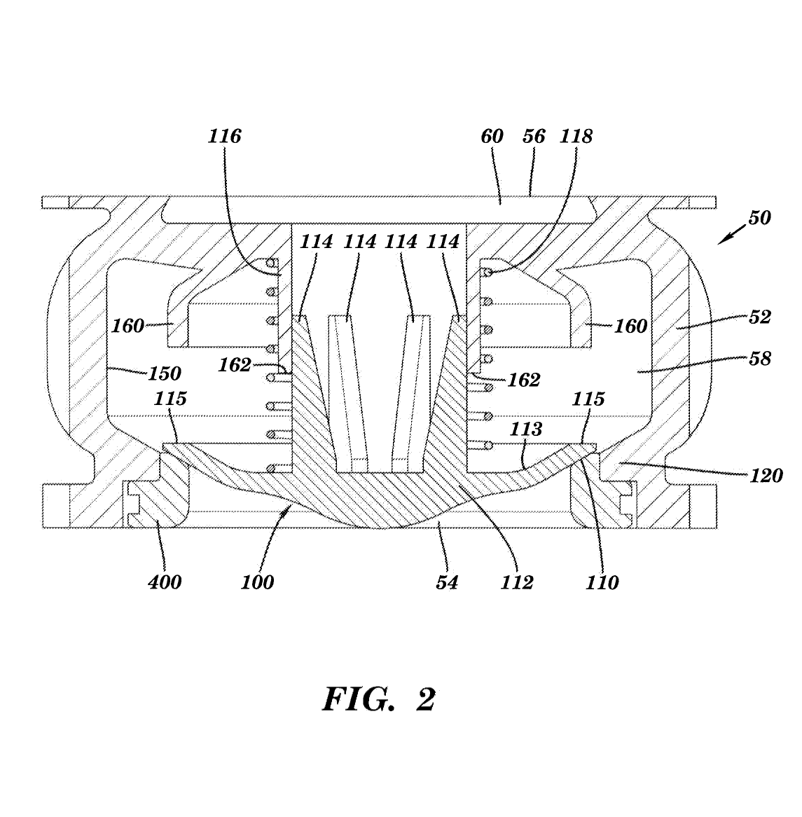

Referring now to FIG. 2, valve 50 is shown in a closed position with valve head or disk 112 of poppet valve 100 engaging valve seat 110 of flange 120. More specifically, valve head or disk 112 is in contact with flange 120, and a water-tight seal is formed. Fluid cannot pass beyond valve disk 112 when in contact with flange 120. As the force exerted by water pressure on valve disk 112 overcomes the force exerted by a spring 118, shown in FIG. 1, valve disk 112 is displaced towards outlet port 56, shown in FIG. 1, and valve head or disc 112 disengages from valve seat 110 of flange 120

Referring now to the illustrative embodiment shown in FIGS. 1-3, plurality of guide legs 114 of poppet valve 100 extend from valve disk 112 into the downstream portion 60 of housing 52 of valve 50. Plurality of guide legs 114 may be formed integral with, or affixed to, valve head or disk 112. In one embodiment, poppet valve 100 may include six guide legs 114, as illustrated in FIG. 3. Alternative embodiments may include more or less guide legs 114 depending on the radial support desired or required for the smooth operation of the valve. Contrary to conventional check valves, plurality of guide legs 114 extend away from valve seat 110 and do not extend through valve aperture 122. In one embodiment, plurality of guide legs 114 are telescopically received by a guide 116. Guide 116 aids in guiding the reciprocating movement of poppet valve 100 within housing 52 during opening and closing of valve 50. As valve disk 112 moves towards and away from valve seat 110, plurality of legs 114 cooperates with the inner surface of guide 116 to maintain valve disk 112 substantially in alignment with valve seat 110. For example, each of the plurality of legs 114 includes an outer surface 115 that faces the inner surface of guide 116. As poppet 100 moves between an open and closed position, the outer surfaces of the plurality of legs 114 are guided by the inner surface of guide 116.

In contrast to existing valves that include, for example, a valve stem or shaft extending from a valve head and telescopically received by a guide with a bushing, plurality of guide legs 114 result in less friction loss and provide a larger flow area when valve 50 is in an open position. The use of a plurality of guide legs 114 instead of, for example, a valve stem or shaft and guide bushing, provides quicker movement of poppet valve 100 which lowers hydraulic shock from water hammer surges during pump shut-down or power failure. Plurality of guide legs 114 use less material than a valve stem or shaft and, therefore, can react faster to changes in frequency or pressure experienced in a hydraulic system. For example, plurality of guide legs 114 would close faster than a conventional poppet valve using a valve stem or shaft because the plurality of legs 114 would be lighter in weight. The use of a plurality of guide legs 114 also provide self-cleaning of the valve as compared to a valve stem or shaft that is closely guided in a bushing positioned in a typical guide. The use of a plurality of legs 114 guided by guide 116 as compared to a valve stem or shaft received by a bushing disposed in a guide also results in less parts (e.g. no bushing) and is easier to assemble and/or repair.

In traditional valves, the outer diameter of a valve stem or shaft used with a valve disk is much smaller when compared to the outer diameter of the valve head. Specifically, the outer diameter of a valve stem or shaft used with a valve head found in a traditional valve is approximately thirteen percent of the outer diameter of the valve head. When used in with pumps with variable frequency drives that are capable of generating varying rates of fluid flow, traditional valve stems fail to provide the necessary support or stability because, for example, the guide surface of the stem or shaft is too far away from the hydraulic forces at the edge of the valve disk or head.

In one embodiment, the outer diameter formed by outer or guide surfaces 115 of the plurality of guide legs 114 is approximately forty percent of the outer diameter formed by the outer peripheral surfaces of valve head 112. In comparison to traditional valves, the outer diameter formed by outer or guide surfaces 115 of the plurality of guide legs 114 in this embodiment is approximately three times greater than the outer diameter formed by a traditional valve stem. In this example, outer or guide surfaces 115 of plurality of legs 114 are closer to the hydraulic forces being subjected to valve head 112 to provide better stability and support to poppet valve 100 during operation, especially during changes experienced with variable frequency drive pumps. In alternative embodiment, the outer diameter formed by outer or guide surfaces 115 of the plurality of guide legs 114 may be larger or smaller than forty percent of the outer diameter of valve head 112.

Guide 116 is sized to telescopically receive outer surfaces 115 of plurality of guide legs 114. In an embodiment where the outer diameter formed by outer surfaces 115 of plurality of guide legs 114 is approximately three times greater than the outer diameter of a traditional valve stem or shaft, the inner diameter of guide 116 is larger than the inner diameter of a bushing used to guide a valve stem or shaft of a traditional valve. A larger inner diameter guide provides improved mechanical support in response to the hydraulic forces subjected to valve disk 112. In one embodiment, guide 116 is includes a passageway in communication with upstream portion 182 and downstream portion 60. The flow passing through guide 116 results in less friction losses and self-cleaning guide for plurality of legs 114.

In one embodiment, guide 116 is removeably mounted to inner surface 150 of housing 52 in downstream portion 60 of valve 50. Guide 116 may be secured or locked in place in downstream portion 60 of valve 50 by, for example, the method described in U.S. Pat. No. 9,032,992, which is hereby incorporated herein by reference. In alternative embodiments, guide 116 may be permanently affixed to inner surface 150 of housing 52. Unlike conventional poppet valves that need to be fully open for proper support, guide 116 provides support to poppet valve 100 throughout the opening and closing of valve 50, even when valve 50 is only partially open. Also, a valve constructed in accordance with one or more principles of the present invention does not rely on a stem having guide legs extending through a valve aperture for stability and proper operation of the valve. Without use of such guide legs, poppet valve 100 may become lodged in or with the interior seat. In alternative embodiments, guide 116 may be removeably mounted to inner surface 150 of housing 52 in other ways, including, for example, without the use of a guide ring 132 or by using other means not illustrated such as, for example, using other fasteners, such as, for example, screws, rivets or the like, heat shrinking, shrink fitting, press fitting, snap fitting and the like. In one embodiment, the outer peripheral surface 174 of support arms 172 may mate with an annular groove 202 in inner surface 150 of housing 52 without the use of a guide ring.

Referring to the illustrative embodiments of FIGS. 1 and 2, an elastomeric spring means such as, for example, a stainless steel coil spring 118, biases valve disk 112 in the closed position against valve seat 110. Spring 118 is telescoped over the outer diameter of guide 116. A first end of spring 118 is supported or, alternatively, anchored against guide 116. Opposite end of spring 118 is supported or, alternatively, anchored against valve disk 112. In each of the embodiments listed above, the diameter of spring 118 is larger than the outside diameter of the plurality of guide legs 114. A spring 118 having a larger diameter spreads the force of the spring about a large area of valve disk 112, resulting in a more stable resistance to the pressure of fluid against valve disk 112. In one embodiment, the diameter of spring 118 is approximately three times greater than the diameter of a spring used with traditional valves. A larger spring diameter provides a biasing spring force closer to the outer edges of the valve disk 112 resulting in better stability and guiding of poppet valve 110 during travel between a fully opened and fully closed locations when compared to traditional valves.

Valve 50 operates in the usual manner of a check valve to provide an opening in the valve when the pressure in upstream portion 182 of valve housing 52 is sufficient to overcome the force imposed on valve disk 112 by spring means and to be closed by action of spring means when the pressure upstream of the valve is decreased. In one embodiment, valve 50 may include a valve head stop 160 disposed in the housing. When the valve is fully open and when the flow velocities and the hydraulic forces are the highest on valve disc 112, valve disc 112 is fully supported on the peripheral back edge 115 by valve head stop 160. Valve head stop 160 contacts valve head 112 in the fully open position and prevents valve head 112 from moving further into downstream portion 60. In an alternative embodiment, valve head 112 may be prevented from moving further into downstream portion 60 by the end portion 162 of guide 116. In one such example, guide 116 may be equipped with a skirt shaped surface designed to support valve head 112 in the fully opened position and also prevent vortex forces from working on the backside 113 of valve head 112. A guide 116 having a skirt shaped surface will limit cavitation and provides improved stability as valve head 112 moves between an open position and a closed position, especially during high flow velocities.

In traditional valves, the poppet valve typically is positioned in a vertical position, such that an outlet port is directly above and in line with an inlet port, such that the flow of water is against the pull of gravity. However, a valve constructed in accordance with the principles of the present invention may be placed in alternative positions. For example, poppet valve 100 may be placed in a horizontal position where inlet port 54 and outlet port 56 lie at the same relative altitude rather than outlet port 56 being positioned above inlet port 54, such that the flow of water is normal to the pull of gravity. In another example inlet port 54 may be positioned above outlet port 56, such that the flow of water is in the same direction as the pull of gravity. A check valve constructed in accordance with the principles of the present invention may be installed in substantially any direction, permitting fluid flow in substantially any direction. The increased stem diameter 142 and length 162 of surface 160 of guide 116 result in a more stable poppet assembly 110, resulting in a check valve 100 that may be placed in alternative positions.

While embodiments of the invention have been illustrated and described in detail in the disclosure, the disclosure is to be considered as illustrative and not restrictive in character. All changes and modifications that come within the spirit of the invention are to be considered within the scope of the disclosure.

1. A valve, said valve comprising:
a housing including an inner periphery surface defining a passage therethrough between an inlet port and an outlet port;
a flange within said housing dividing the passage between the inlet and outlet ports into an upstream portion and a downstream portion, said flange extending circumferentially around the inner periphery surface of said housing, the flange defining a valve seat and having an inner surface defining a valve aperture;
a poppet valve positioned in the downstream portion of the passage of said housing, said poppet valve including a valve head and a plurality of guide legs extending from the valve head towards the outlet port of said housing, the valve head engaging the valve seat of said flange and moveable between a closed position to a fully open position, the valve head being resiliently biased in the closed position against the valve seat to inhibit fluid flow in a first direction and allow fluid flow in an opposite direction to the first direction; and
a guide mounted on the inner periphery surface of said housing, said guide guiding the plurality of guide legs of said poppet valve as said poppet valve moves between the closed position and the fully open position.

2. The valve of claim 1, wherein said guide is removeably mounted to the inner periphery surface of said housing.

3. The valve of claim 1 further comprising spring means for biasing said poppet valve towards a closed position.

4. The valve of claim 1, wherein said guide telescopically receives the plurality of guide legs of said poppet valve as said poppet valve moves between the closed position and the fully open position

5. The valve of claim 1, wherein the valve seat includes a removable rubber disk, wherein the valve head contacts the removable rubber disk in a closed position.

6. The valve of claim 1, further comprising a valve head stop positioned within said housing, said valve head stop contacting the valve head in the fully opened position.

7. The valve of claim 6, wherein the valve head includes a back edge, wherein the valve head stop contacts the back edge of the valve head.

8. The valve of claim 7, wherein the guide includes a bottom edge, wherein the valve head contacts the bottom edge of the guide in the fully opened position.

9. The valve of claim 1, wherein each plurality of guide legs includes an outer surface facing said guide, wherein the outer surfaces of the plurality of guide legs define an outer diameter, wherein the outer diameter of the plurality of guide legs is approximately forty percent smaller in relation to an outer diameter of the valve head.

10. The valve of claim 1, wherein said guide does not include a bushing.

11. The valve of claim 1, wherein the valve head is resiliently biased in the closed position against the valve seat by a spring.

12. The valve of claim 1, wherein a passageway is defined through the guide to permit flow between the plurality of guide legs for a reduction in friction loss and self-cleaning.

13. The valve of claim 1, wherein the guide includes an end surface configured to contact the valve head in the fully open position and to prevent vortex forces on a backside of the valve head.

13. A valve, said valve comprising:
a housing including an inner periphery surface defining a passage therethrough between an inlet port and an outlet port;
a flange within said housing dividing the passage between the inlet and outlet ports into an upstream portion and a downstream portion, said flange extending circumferentially around the inner periphery surface of said housing, the flange defining a valve seat and having an inner surface defining a valve aperture;
a poppet valve positioned in the downstream portion of the passage of said housing, said poppet valve including a valve head and a plurality of guide legs extending from the valve head towards the outlet port of said housing, the valve head including an outer diameter, the valve head engaging the valve seat of said flange and moveable between a closed position to a fully open position, the valve head being resiliently biased in the closed position against the valve seat to inhibit fluid flow in a first direction and allow fluid flow in an opposite direction to the first direction, each of the plurality of guide legs including an outer surface that together form an outer diameter of the plurality of guide legs, wherein the outer diameter of the plurality of guide legs is approximately forty percent of the outer diameter of the valve head; and
a guide mounted on the inner periphery surface of said housing, said guide telescopically receives the plurality of guide legs of said poppet valve as said poppet valve moves between the closed position and the fully open position.
